(19) United States
(12) Patent Application Publication
(10) Pub. No.: US 2002/0141402 A1
(43) Pub. Date: Oct. 3, 2002

(54) Telecommunication auto-looper

(76) Inventors: Li-tien Chang, Oak Brook, IL (US); Richard L. Kao, Northbrook, IL (US)

Correspondence Address: Mark E. Fejer, Pauley Petersen Kinne & Fejer, Suite 365, 2800 West Higgins Road, Hoffman Estates, IL, 60195, US

(21) Appl. No.: 09/802,292

(22) Filed: Mar. 8, 2001

(51) Int. Cl. H04L 12/28

(52) U.S. Cl. 370/389; 370/419

(57) ABSTRACT

An auto-looper for a telecommunications network. The auto-looper detects the existence of continuity in a network path between at least two nodes of the network by activating at least one switch connecting the at least two nodes upon receipt of at least one addressable code to produce a loop-up state or a loop-down state.

### BACKGROUND OF THE INVENTION

1. Field of the Invention

This invention relates to a method and apparatus for determining the continuity of a network path of a telecommunication system. More particularly, this invention relates to a device referred to as an auto-looper which activates one or more switches connecting two or more nodes of a network, resulting in the device being in a loop-up condition or a loop-down condition, with the loop-down condition being the normal connecting state.

2. Description of Prior Art

When a problem arises in a network, such as, for example, between the equipment of a service provider and equipment located on the premises of a customer, it is usually necessary to dispatch an installer or field tester to the customer for end-to-end testing. In addition to being time-consuming, it is also frequently disruptive and inconvenient to the customer, requiring that the customer adjust his or her schedule to correspond to the schedule of the installer or field tester. This is particularly true in the case of water, gas, or electrical meter reading.

Methods and devices for evaluating the condition of a line in a network are known. U.S. Pat. No. 4,660,194 to Larson et al. is exemplary of such prior art and teaches a method and apparatus for testing a subscriber's line in a packet switch multiplex data/voice communication system by establishing loopbacks at various locations along the line. Timed loopbacks along the subscriber line are effected by purposefully extinguishing or killing the data carriers serving the line. The data carrier is then restored while the loopbacks are maintained. By properly adjusting the timing of the loopbacks, test signals transmitted down the line are returned by the loopbacks to provide an indication of the status of corresponding sections of the line.

U.S. Pat. No. 4,563,774 to Gloge teaches a communication network requiring no synchronization circuits, whose access ports are independent of each other, and where analog and digital access ports can be mixed in the same network. The system uses address coding of individual baseband data bits (or speech sample bits) enabling a receiver to recognize its (address) message in the background of other and different (address) encoded messages. The message samples are appropriately distributed or switched independently from one another. No formal framing is necessary and queuing delays are absent.

U.S. Pat. No. 3,879,710 to Maxemchuk et al. teaches a looped data communication system which utilizes a time division multiplexing technique for efficiently subdividing and switching the loop transmission capacity among the various terminals on the loop. The switching functions are distributed around the loop as opposed to a central switching device, such as a computer. A terminal clock signal is derived from a signal received from the loop at a nodal point. The derived clock precisely identifies the time slot assigned to the particular terminal, eliminating the need for a guard space or a buffer zone between transmissions from different terminals.

U.S. Pat. No. 6,061,725 to Schwaller et al. teaches a system for testing a communication network utilizing a test scenario determined based upon a type of application traffic expected on the network to be tested. A console node is provided on the network for establishing the test scenario and assigning the test scenario an endpoint node specific test protocol. Execution of the test protocols by the endpoint nodes is initiated by the console node. Performance data, such as throughput, transaction rate and response time may be monitored at selected ones of the endpoint nodes and reported to the console node, either as it is generated or after completion of the test. The test scenario may be terminated when all endpoint node specific test protocols have completed execution or when any one endpoint completes execution of its test protocol.

U.S. Pat. No. 5,991,891 to Hahn et al. teaches a method and apparatus for providing loop coherency between a plurality of nodes utilizing a primary loop for nominal data communications and a normally unutilized secondary loop. A loop coherency circuit detects a loop incoherency condition which results in an interruption of the primary loop. The loop coherency circuit reroutes the flow of data to a secondary loop segment and back to a primary loop segment to provide a continuous coherent arbitrated loop.

And, finally, U.S. Pat. No. 4,064,369 to Battocletti teaches a method and apparatus for path continuity testing in which a continuity word is inserted into one part of a network path, the outputs and inputs of the path are coupled to form a loop to circulate the continuity word, and a comparison is made between the original continuity word and the word as detected at a predetermined point of the loop, to supply a verify signal indicating that the two words are identical.

Although methods and devices are known for determining the continuity of a network path as evidenced by the above prior art, these known methods and devices are relatively expensive and complex. Thus, there is a need for a convenient, simple and inexpensive method and device for determining the continuity of a network path.

### SUMMARY OF THE INVENTION

Accordingly, it is one object of this invention to provide a convenient and economic method and device for determining the continuity of a network path.

It is another object of this invention to provide a convenient and economic method and device which enables remote reading of a utility meter.

These and other objects of this invention are addressed by a telecommunication device comprising detection means for detecting an existence of continuity in a network path between at least two nodes of a network whereby addressable codes activate at least one switch connecting the at least two nodes to produce a loop-up state or a loop-down state. The at least one switch is in a closed position during the loop-up state and in an open position during the loop-down state. The detector means comprises an intelligent timing circuit adapted to control a time period for each of the loop-up state and the loop-down state assigned to the at least one switch. With the intelligent timing control, the loop-up state can be returned to the loop-down state when the programmed loop-up time specified in the intelligent timing circuit expires. Alternatively, the timing control can be overridden by the transmission of a further addressable code which returns the switch to a loop-down state.

In operation, an addressable code is sent to the detection means, resulting in the at least one normally open switch closing and the generation of a loop-up state. An addressable loop-up acknowledgment code is transmitted using the detection means to the network. During the loop-up state, continuity of the network can be tested. Thereafter, the at least one normally open switch is opened, resulting in a loop-down state. An addressable loop-down code is then transmitted using the detection means to the network. In the loop-down state, which is the normal connecting state, the auto-looper functions as a pass-through connector.

The auto-looper of this invention can be applied to many different kinds of network connections including 1 wire-to-1 wire, 2 wires-to-2 wires, 4 wires-to-4 wires, 6 wires-to-6 wires, and so on. In addition, it can be looped up at any time that an addressable loop-up code is received from the network. If the addressable loop-up code is received from the far end of the network, the continuity can be checked at that point. The auto-looper in accordance with one embodiment of this invention can detect any pre-existing hard-loops in the network and send a short alarm message to the network located at the far end. The auto-looper of this invention also has the capability to correct a transverse connection between the network and customer premise equipment automatically. The auto-looper of this invention may loop-up a spare line either for testing purpose or for a backup. The auto-looper of this invention can loop-up a sending signal/code to a transmitter. When the sending signal/code is echoed back from the transmitter to a test center or the far end of the network, the continuity of the line connection and wireless medium has been tested. This is one way to monitor the performance of network connections without interrupting the normal traffic for telecommunications.

The auto-looper of this invention is adaptable to a wide range of configurations. It can be built into a wiring block and it can be built into other connecting devices, such as patch panels, connecting adapters, and connecting cabinets. In this fashion, each device into which the auto-looper of this invention is inserted has the capability of testing the continuity of a network path. In general, the auto-looper can be applied in many applications as a remote control device in which the embedded switches can be turned on or off by addressable loop-up or loop-down codes from the far end of the network. For example, house appliances such as slow cookers, lights, and VCRs can be turned on and off by means of the auto-looper and a telephone line from a remote control site. Likewise, the readings of utility meters can be made on a timely basis.

### BRIEF DESCRIPTION OF THE DRAWINGS

These and other objects and features of this invention will be better understood from the following detailed description taken in conjunction with the drawings wherein:

FIG. 1 is a block diagram of an auto-looper in accordance with one embodiment of this invention;

FIG. 2 is a diagram of a switched loop-up/loop-down system with microprocessor control in accordance with one embodiment of this invention;

FIG. 3 is a schematic diagram of a signal/code detector for the auto-looper system in accordance with one embodiment of this invention;

FIG. 4 is a schematic diagram showing detection of a network short and transverse correction;

FIG. 5 is a schematic diagram of a wiring block with auto-looper capability built in;

FIG. 6 is a schematic diagram showing an auto-looper circuit in combination with a patch panel;

FIG. 7 is a diagram showing control of a house appliance from a remote control site using the auto-looper of this invention; and

FIG. 8 is a diagram of a system for remote reading of utility meters using an auto-looper in accordance with this invention.

### DETAILED DESCRIPTION OF PRESENTLY PREFERRED EMBODIMENTS

The auto-looper of this invention is an intelligent device for looping up or looping down a network path when a proper code has been received. It is designed for many applications, including utility meter reading, remote control of house appliances and determining the continuity of a network path between two or more nodes in the network. And as will be seen, there are a variety of connectors to the network that can be employed.

In a network to which customer premise equipment is attached, the auto-looper is a pass-through device between the network and the customer premise equipment when it is looped down. However, once it is looped up, the continuity of both the network side and the customer premise equipment side can be tested. The logic and the components used in the auto-looper meet all the software/hardware standards. The codes for loop-up and loop-down conditions can be wired or wireless.

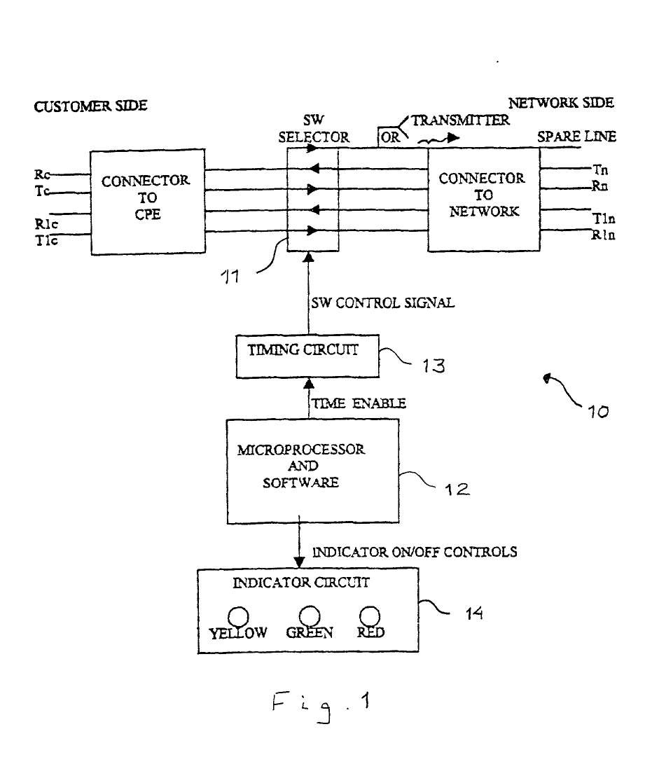

FIG. 1 is a block diagram of an auto-looper in accordance with one embodiment of this invention. Auto-looper 10 comprises at least one switch 11 connecting the network transmitter (Tn) and receiver (Rn) lines and the transmitter (Tc) and receiver (Rc) lines of the customer premise equipment, a microprocessor and software 12, a timing circuit 13 and an indicator circuit 14. Indicator circuit 14 comprises three lights, yellow, green and red, which can be used to instantaneously determine the status of the auto-looper 10. The microprocessor and software 12 include addressable codes for controlling switch 11. Upon receipt of an addressable code, switch 11, which is normally open, is closed, creating a loop-up state during which continuity between auto-looper 10 and a node on the network and auto-looper 10 and the customer premise equipment can be determined. A second addressable code can be used to open switch 11, thereby returning the auto-looper 10 to a loop-down state. Alternatively, timing circuit 13 may be used to automatically open switch 11 so as to return auto-looper 10 to a loop-down state. Auto-looper 10 is capable of detecting a pre-existing hard-loop in the network and correcting a transverse connection between the network and customer premise equipment automatically. As shown in FIG. 1, a spare line or transmitter can also be looped-up.

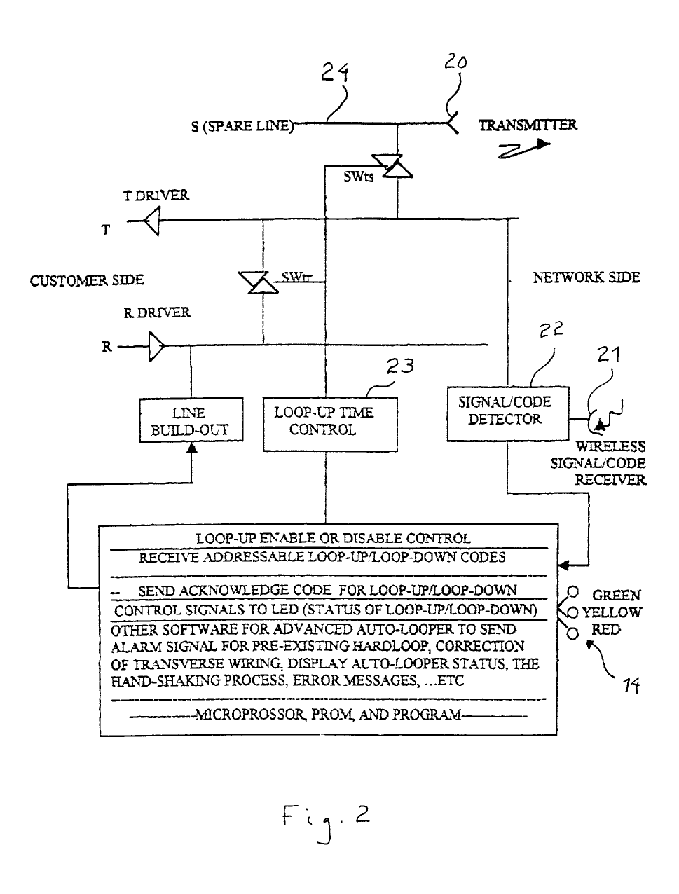

FIG. 2 is a diagram showing microprocessor control of the loop-up and loop-down states of switch 1 1. The microprocessor and software comprise means for receiving addressable loop-up and loop-down codes, means for sending an acknowledge code acknowledging a loop-up or loop-down condition, and means for controlling indicator lights by which the status (loop-up or loop-down) of auto-looper 10 can be determined. The software may also include means for sending an alarm signal for a pre-existing hard-loop, correction of transverse wiring, error messages, etc.

As shown in FIG. 2, an addressable code may be transmitted by a wireless transmitter and received by wireless signal/code receiver 21 for input into signal/code detector 22. Upon receipt of the addressable code, the microprocessor and software generates an acknowledge code for a loop-up condition to switches SWtr and SWts, causing them to close, creating a loop-up condition. As previously stated, the auto-looper of this invention comprises a timing circuit by which the length of time of a loop-up or loop-down condition is set. In FIG. 2, loop-up time control 23 is operatively connected to switches SWtr and SWts. After expiration of a set period of time, loop-up time control 23 causes the switches, shown in a loop-up state, to open, returning to a loop-down state. Wireless transmitter 20 may transmit an acknowledge code for a loop-up or loop-down condition. As shown in FIG. 2, when switch SWts is in a loop-up state, access to spare line 24 is provided.

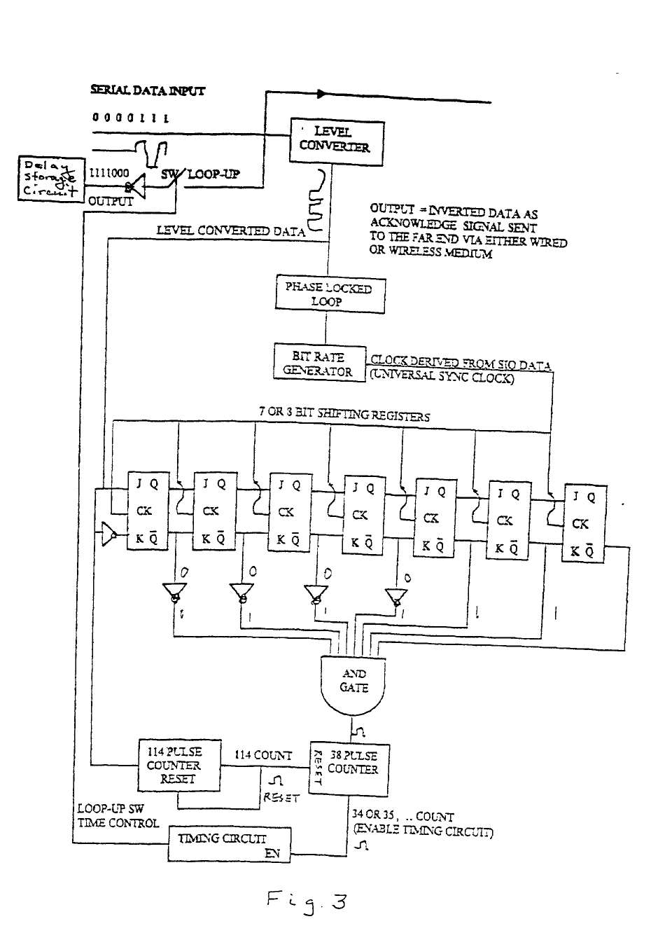

FIG. 3 is a schematic diagram of the primary circuitry of the signal/code detector 22. In FIG. 3, the seven-digit code, 0000111, is used as a loop-up code and is transmitted into seven-bit shifting registers. A clock derived from SIO data is provided, which is synchronized for strobing the data into the 7-bit shifting registers. Counters are provided to secure the loop-up switch so that it will not be triggered accidently. As shown in FIG. 3, the acknowledge code, which may be sent by the auto-looper by either wired or wireless means, corresponds to an inversion of the data input.

### EXAMPLE 1

| Address #1 | Address #2 | Address #3 |
|---|---|---|
| CPE---Auto-looper---------- | Auto-looper------------------- | Auto-looper---FAR END |
| Site 1 | Site 2 | Site 3 Site n |

In this example, Site n sends an addressable loop-up code to Site 3. The connection from Site n to Site 3 can then be checked. The line condition can be examined as various performance signals are sent from the FAR END to Site 3 and looped back. After the connection between Site n and Site 3 has been confirmed to be good, the connection between Site n and Site 2 can be confirmed in a similar manner. This procedure can be repeated for each Site or node within the network.

### EXAMPLE 2

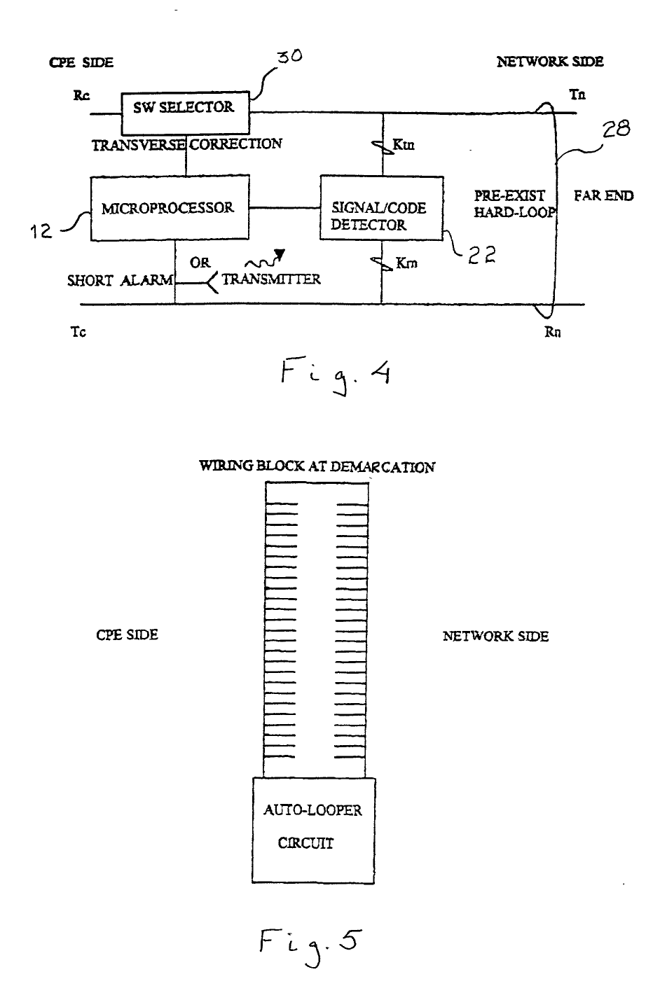

In this example, shown in FIG. 4, the auto-looper of this invention is used as a means for detecting a short in the network and automatically providing a correction therefor. If a signal is detected by signal/code detector 22 on both sides of Tn and Rn for an extended period of time, there is a hard loop 28 (a short between Tn and Rn) in the network path. In this case, the microprocessor of the auto-looper of this invention generates a short alarm signal, which is sent to the network at the far end. The hard-loop, having been detected by the auto-looper, can then be removed. Thus, the auto-looper of this invention can be used to troubleshoot a short between T and R in the network path. After checking for any short between T and R, the auto-looper can then take the loop-up code for the purpose of network testing.

In accordance with one embodiment of this invention, if a signal is detected by the microprocessor of the auto-looper on the Rn side through Krn, indicating that the connection of the network to the auto-looper is transverse, the microprocessor of the auto-looper can generate a control signal to switch the connection by means of switch selector 30 between the network and the customer premise equipment (CPE) from Tn-Rc/Tc-Rn to Rn-Rc/Tc-Tn automatically as a correction.

As previously stated, the auto-looper of this invention is adaptable to a variety of network applications. FIG. 5 shows an auto-looper in accordance with one embodiment of this invention incorporated into a wiring block and FIG. 6 shows an auto-looper incorporated into a patch panel. However, the auto-looper is also adaptable for use in connecting adapters, connecting cabinets, switchgear cabinets and the like.

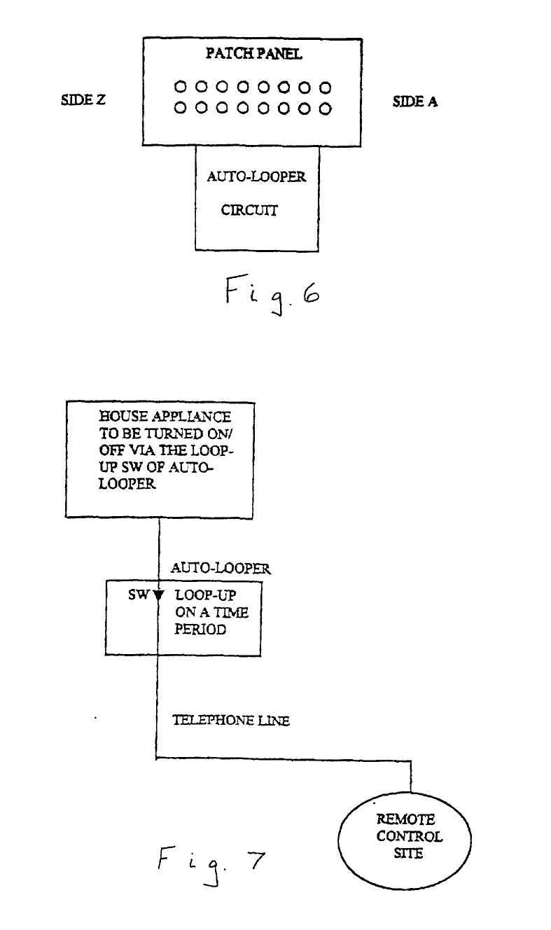

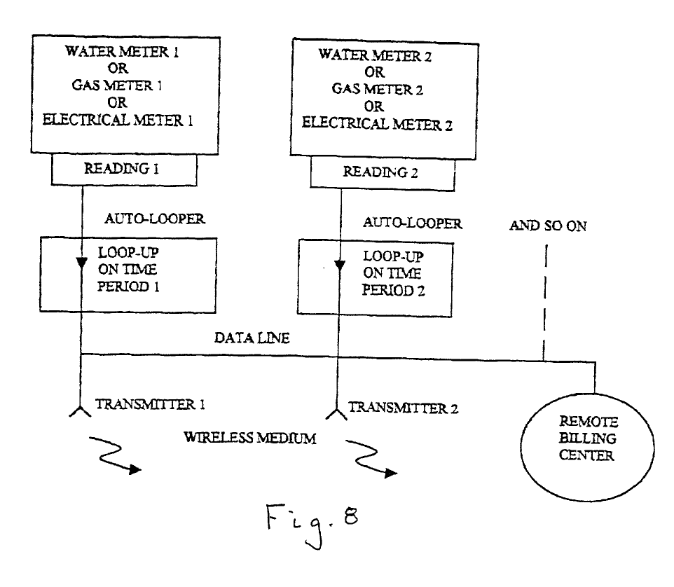

FIG. 7 is a diagram showing an auto-looper in a system for remote control of remotely located appliances, such as appliances in a home. The auto-looper is disposed in a network (e.g. telephone line) between a remote control site and the home appliance to be controlled. In this application, the addressable code for a loop-up condition is transmitted from the remote control site, either by way of a telephone line or by wireless means, to the auto-looper, which, in turn, produces a loop-up condition under which power is supplied to the appliance. If the auto-looper has a timing circuit, it can be used to automatically turn on/off the appliance based upon a preset time period.

FIG. 8 is a diagram showing yet another application of the auto-looper of this invention for utility meter reading. In this case, readings of the meters are monitored on a timely basis by means of a loop-up switch of the auto-looper. Data is sent to a remote billing center at different time periods, as determined by the timing circuit for the loop-up/loop-down condition of the switch, either by way of a shared data line or by way of a wireless medium.

As previously indicated, the auto-looper of this invention is highly adaptable to a variety of applications. It is suitable for use in single- or multi-wire network applications. The connections to the network can be adapted to whatever is required to connect the device to the network. In accordance with one embodiment of this invention, the auto-looper of this invention comprises a malfunction indicator for times when switches stay in a loop-up state when the time period assigned for the loop-up state has expired or the addressable loop-down code cannot be executed properly.

In accordance with one embodiment of this invention, the auto-looper comprises a delay storage circuit as shown in FIG. 3 which can be used for testing one-way cable. In this case, the sending signal/code stored in the shifting registers with a delay time are able to echo back to the network when the traffic of the one-way path is clear. The shifting registers of the auto-looper in accordance with one embodiment of this invention enable use of the auto-looper as a digital filter by passing the data through a series of shifting registers.

In accordance with one embodiment of this invention, the auto-looper can be used as a buffer for digital data input and output. In this case, as previously indicated, the data clock will be synchronized with the data speed.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. A telecommunication device comprising:
detection means for detecting an existence of continuity in a network path between at least two nodes of a network whereby addressable codes activate at least one switch connecting said at least two nodes to produce one of a loop-up state and a loop-down state.

2. A telecommunication device in accordance with claim 1, wherein said at least one switch is in a closed position during said loop-up state and in an open position during said loop-down state.

3. A telecommunication device in accordance with claim 1, wherein said detector means comprises a timing circuit adapted to control a time period for at least one of said loop-up state and said loop-down state assigned to said at least one switch.

4. A telecommunication device in accordance with claim 1, wherein said detector means comprises indicator means for determining a status of said device.

5. A telecommunication device in accordance with claim 4, wherein said indicator means indicate at least one of said loop-up state, said loop-down state and a malfunction state.

6. A telecommunication device in accordance with claim 5, wherein said indicator means comprises a plurality of light indicators, each of said light indicators corresponding to one of said loop-up state, said loop-down state and said malfunction state.

7. A telecommunication device in accordance with claim 1 further comprising means for receiving said addressable codes by wireless means.

8. A telecommunication device in accordance with claim 1, wherein said detection means comprises a delay storage circuit.

9. In a telecommunication network comprising at least two nodes and at least one detection means for detecting an existence of continuity in a network path joining said at least two nodes, said detection means comprising at least one normally open switch connecting said at least two nodes, a method for determining the continuity of said network path comprising the steps of:
sending an addressable code to said detection means, resulting in said at least one normally open switch closing and generation of a loop-up state; and
transmitting an addressable loop-up acknowledgment code with said detection means to one of said two nodes, resulting in a determination of the continuity of the network path between said detection means and said one of said two nodes.

10. A method in accordance with claim 9, wherein said closed normally open switch is opened, resulting in a loop-down state.

11. A method in accordance with claim 9, wherein said loop-up state results in one of a turning on and turning off of an appliance connected to said network.

12. A method in accordance with claim 9, wherein said addressable code is transmitted to said detection means by wireless means.

13. A method in accordance with claim 9, wherein said addressable code is transmitted by wired means.

14. A method in accordance with claim 9, wherein said loop-up state is terminated by a timing circuit.

15. A telecommunications network comprising:
at least two nodes;
a network path connected to each of said at least two nodes and providing a communication there between; and
detector means comprising at least one normally open switch and at least one addressable code whereby, upon transmission of said addressable code to said detection means, said at least one normally open switch closes, creating a loop-up state, said at least one normally open switch connecting said detector means to said network path between said at least two nodes.

16. A telecommunications network in accordance with claim 15, wherein said detector means comprises a timing circuit, said timing circuit controlling a length of time of said loop-up state.

17. A telecommunications network in accordance with claim 15, wherein said detector means comprises indicator means for determining a status of said detector means.

18. A telecommunications network in accordance with claim 17, wherein said indicator means indicate at least one of said loop-up state, a loop-down state and a malfunction state.

19. A telecommunications network in accordance with claim 17, wherein said indicator means comprises a plurality of light indicators, each of said light indicators corresponding to one of said loop-up state, said loop-down state and said malfunction state.

20. A telecommunications network in accordance with claim 15, wherein said detector means comprises means for receiving said addressable codes by wireless means.

21. A telecommunications network in accordance with claim 15, wherein said detector means comprises a delay storage circuit.

22. A telecommunications network in accordance with claim 15, wherein said detector means comprises a microprocessor and software.
